(19) United States
(12) Patent Application Publication
(10) Pub. No.: US 2015/0259189 A1
(43) Pub. Date: Sep. 17, 2015

(54) TRAINING HALTER FOR HORSES

(71) Applicant: Tommie Carroll Gipson, Eaton, CO (US)

(72) Inventor: Tommie Carroll Gipson, Eaton, CO (US)

(21) Appl. No.: 14/623,100

(22) Filed: Feb. 16, 2015

Related U.S. Application Data
(63) Continuation-in-part of application No. 14/206,465, filed on Mar. 12, 2014.
(60) Provisional application No. 62/086,916, filed on Dec. 3, 2014.

(51) Int. Cl. B68B 1/02; A01K 27/00

(52) U.S. Cl. CPC B68B 1/02; A01K 27/003

(57) ABSTRACT

A training halter has a nose loop configured to encircle the nose of a horse, a head loop configured to encircle the head of the horse from the poll to the chin groove and a right strap, a left strap, and a chin strap that connect the nose loop and the head loop. A preferred embodiment of the training halter has a selectably removable band of multiple pressure protrusions positioned to apply pressure to a horse's nose and/or poll when the halter is pulled down and/or backward. A training halter having a nose loop with pressure protrusions and/or a head loop with pressure protrusions is more effective for training a horse not to pull away from a post.

### CROSS-REFERENCE TO RELATED APPLICATION

The present application, pursuant to 35 U.S.C. 111(b), claims the benefit of the earlier filing date of provisional application Ser. No. 62/086,916 filed Dec. 12, 2014 and entitled “Training Halter for Horses” and as a continuation in part of application Ser. No. 14/206,465 filed Mar. 12, 2014 and entitled “Shock Absorbing Rope Insert for Livestock.”

### BACKGROUND OF THE INVENTION

1. Field of the Invention

The present invention relates to an animal training halter. More particularly, the invention relates to a halter to be used for non-riding training procedures for horses, where the halter has removable pressure inducing protrusions positioned to selectably apply pressure to the nose and/or poll region of a horse.

2. Description of the Related Art

A variety of halter styles have been developed and utilized for training animals. Most bitless halters (whether riding or non-riding training halters) make use of two loops; one configured to encircle the nose of the animal, and the other extending either about the neck or from the poll to the chin groove. Regardless of the configuration of the halters, all are utilized to exert a downward force against the poll and the bridge of the nose as a discipline measure for training purposes. Since the downward pressure is generally applied across a fairly broad surface area of a nose strap and a poll strap, the pressure applied is often too diffuse to be effective.

One object of the present invention to provide a training halter that will improve the efficiency in training procedures for animals by selectively applying pressure against various areas over selected nerves within the animal's head and nose.

A need exists for an improved training halter that will improve the efficiency of non-riding training procedures for horses.

### SUMMARY OF THE INVENTION

The present invention provides a halter for non-riding training procedures for horses. The halter employs selectably removable pressure inducing protrusions positioned to apply pressure to the nose and/or poll of the horse.

One embodiment of the present invention is a horse halter having two loops; a nose loop configured to encircle the nose of the horse, a head loop configured to encircle the head of the horse from the poll to the chin groove and a right strap, a left strap, and a chin strap that connect the nose loop and the head loop. The nose loop and/or the head loop have a selectably removable band of multiple pressure protrusions positioned to apply pressure to a horse's nose and/or poll when the halter is pulled down and/or backward.

A second embodiment of the present invention is a training halter for horses comprising: a) a nose loop configured to encircle a nose of a horse, the nose loop having an upper segment that aligns with a bridge of the nose of the horse and a bottom segment positional under a chin of the horse; b) a first nose pressure band having a plurality of nose pressure protrusions embedded therein, the nose pressure band selectably attachable to a top side of the upper segment of the nose loop or to a bottom side of the upper segment of the nose loop, wherein when the nose pressure band is attached to the bottom side of the upper segment of the nose loop the nose pressure protrusions transmit pressure to the bridge of the nose whenever a downward tension is applied to the training halter; c) a head loop configured to encircle a head of the horse, the head loop having an upper segment that aligns with a poll region of the horse; and d) a first poll pressure band having a plurality of poll pressure protrusions embedded therein, the poll pressure band selectably attachable to a top side of the upper segment of the head loop or to a bottom side of the upper segment of the head loop, wherein when the poll pressure band is attached to the bottom side of the upper segment of the head loop the poll pressure protrusions transmit pressure to the poll region whenever a rearward tension is applied to the training halter.

A third embodiment of the present invention is an apparatus for training horses including: a) a training halter having i) a nose loop configured to encircle a nose of a horse, the nose loop having an upper segment that aligns with a bridge of the nose of the horse and a bottom segment positional under a chin of the horse, ii) a first nose pressure band having a plurality of nose pressure protrusions embedded therein, the nose pressure band selectably attachable to a top side of the upper segment of the nose loop or to a bottom side of the upper segment of the nose loop, wherein when the nose pressure band is attached to the bottom side of the upper segment of the nose loop the nose pressure protrusions transmit pressure to the bridge of the nose whenever a downward tension is applied to the training halter, iii) a head loop configured to encircle a head of the horse, the head loop having an upper segment that aligns with a poll region of the horse, and iv) a first poll pressure band having a plurality of poll pressure protrusions embedded therein, the poll pressure band selectably attachable to a top side of the upper segment of the head loop or to a bottom side of the upper segment of the head loop, wherein when the poll pressure band is attached to the bottom side of the upper segment of the head loop the poll pressure protrusions transmit pressure to the poll region whenever a rearward tension is applied to the training halter; and b) a stretchable rope insert in communication with the training halter having i) a first end loop and a second end loop, wherein each end loop has multiple coils of a cord material and wherein a first end and a second end of the coiled cord material are joined to form a substantially oval loop with an opening, ii) an expandable shock cord joining the first and second end loops, wherein the shock cord is wound multiple times between the opening in the first end loop and the opening in the second end loop, wherein a first end and a second end of the wound shock cord are joined, and iii) a stretchable elastomeric cover fitted to cover the wound shock cord and a portion of the first and second end loops; and c) a lead rope attached to the stretchable rope insert.

A fourth embodiment of the present invention is A method for training a horse including: a) selecting a first nose pressure band having a plurality of nose pressure protrusions embedded therein; b) selecting a first poll pressure band having a plurality of poll pressure protrusions embedded therein; c) attaching the first nose pressure band on an under side of an upper segment of a nose loop of a training halter; d) attaching the first poll pressure band on an under side of an upper segment of a head loop of a training halter; e) placing the training halter on a head of the horse being trained such that the nose loop encircles a nose of the horse and the nose pressure protrusions are aligned with a bridge of the nose and the head loop encircles the head of the horse and the poll pressure protrusions are aligned with a poll region of the horse; f) attaching a stretchable rope insert to a lead rope; g) attaching the lead rope with the rope insert to a bottom side of the nose loop; h) tying one end of the lead rope to a post; and i) allowing the horse to rear thereby causing the nose pressure protrusions to pressure the bridge of the nose of the horse, or to pull back thereby causing the poll pressure protrusions to pressure the poll region of the horse.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an oblique view of a horse head.

FIG. 2 is an oblique view of one embodiment of a horse training halter.

FIG. 3 is a cross sectional side view of one embodiment of an upper segment of the nose loop of the animal training halter.

FIG. 4 is a cross sectional side view of a first embodiment of a removable nose pressure band containing pressure inducing protrusions.

FIG. 5 is a cross sectional side view of a second embodiment of a removable nose pressure band containing pressure inducing protrusions.

FIG. 6 is a cross sectional side view of a third embodiment of a removable nose pressure band containing an elongated solid material with multiple pressure inducing protrusions.

FIG. 7 is a schematic cross sectional side view of the attachable/detachable nature of the nose pressure band shown in FIG. 4 to the upper segment of the nose loop of the animal halter shown in FIG. 3.

FIG. 8 is a cross sectional side view of one embodiment of an upper segment of the head loop of the animal training halter.

FIG. 9 is a cross sectional side view of one embodiment of the removable poll pressure band containing pressure inducing protrusions.

FIG. 10A is an oblique view taken on one embodiment of the rope insert.

FIG. 10B is an oblique view of an end section of one embodiment of the rope insert.

FIG. 11 is an oblique view of the interior components of one embodiment of the rope insert.

FIG. 12 is a diagram of one embodiment of training a horse with the training halter.

### DESCRIPTION OF THE PREFERRED EMBODIMENTS

Embodiments of the present invention include a halter for non-riding training procedures for horses. The halter employs selectably removable pressure inducing protrusions positioned to apply pressure to a horse's nose and/or poll region.

Throughout the specification, positional terms such as front, rear, left and right refer to the embodiments from the perspective of the horse.

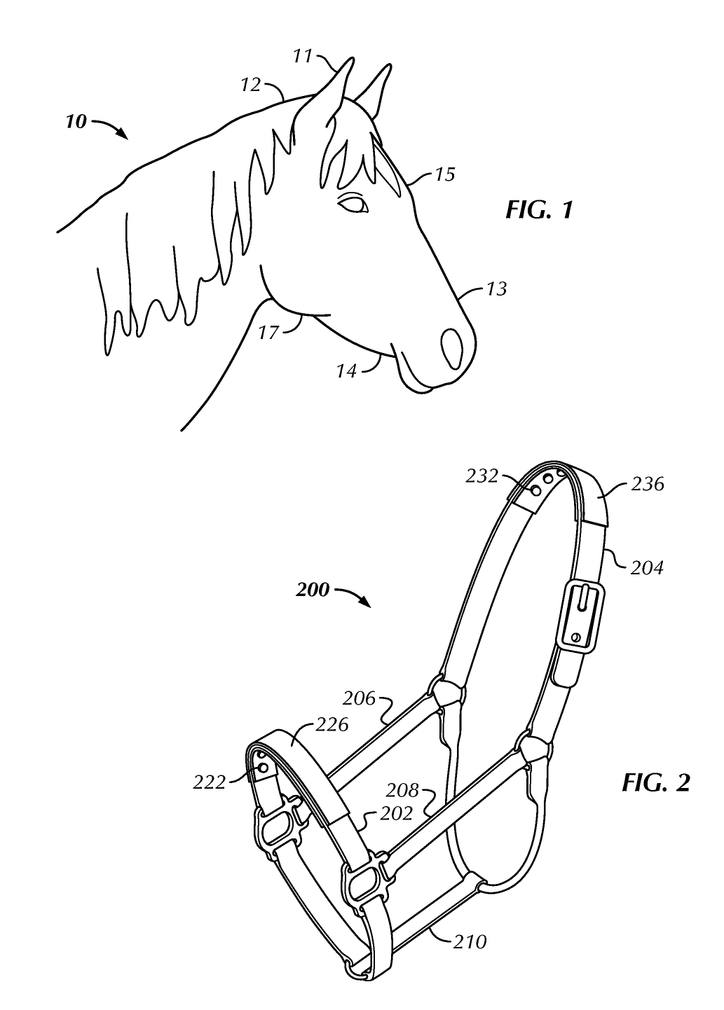

FIG. 1 illustrates the general anatomy of a horse head 10. The head 10 includes the poll region 12 that is behind and adjacent to the ears 11, the chin 14, the nose bridge 15, and the nose 13.

The Training Halter

One embodiment of the present invention is a horse halter 200 having two loops; a nose loop 202 configured to encircle the nose of the horse, a head loop 204 configured to encircle the head of the horse from the poll to the chin groove and a right strap 206, a left strap 208, and a nose-head loop connecting strap 210 that connect the nose loop and the head loop.

A nose pressure band 222 is selectably added or removed from an underside of the nose loop 202. The nose pressure band 222 includes multiple pressure protrusions positioned to apply pressure to a horse's nose 13 when the halter is pulled down. Similarly, a poll pressure band 232 is selectably added or removed from an underside of the head loop 204. The poll pressure band 232 includes multiple pressure protrusions positioned to apply pressure to a horse's poll region 13 when the horse pulls backward on the halter.

A preferred embodiment of the halter 200 is shown in FIG. 2. The halter 200 may be constructed out of woven nylon, leather, rope, or other flexible material. The halter 200 comprises a nose loop 202, a head loop 204, a right strap 206, a left strap 208 and a nose-head loop connecting strap 210. The right strap 206 and the left strap 208 have one end fastened to the right and left sides, respectfully, of the nose loop 202 and a second end fastened to the right and left sides, respectfully, of the head loop 204. The nose-head loop connecting strap 210 has one end fastened at the bottom of the nose loop 202 and a second end fastened to the bottom of the head loop 204. Thus, there are three straps connecting the nose loop 202 and the head loop 204.

The Nose Pressure Band

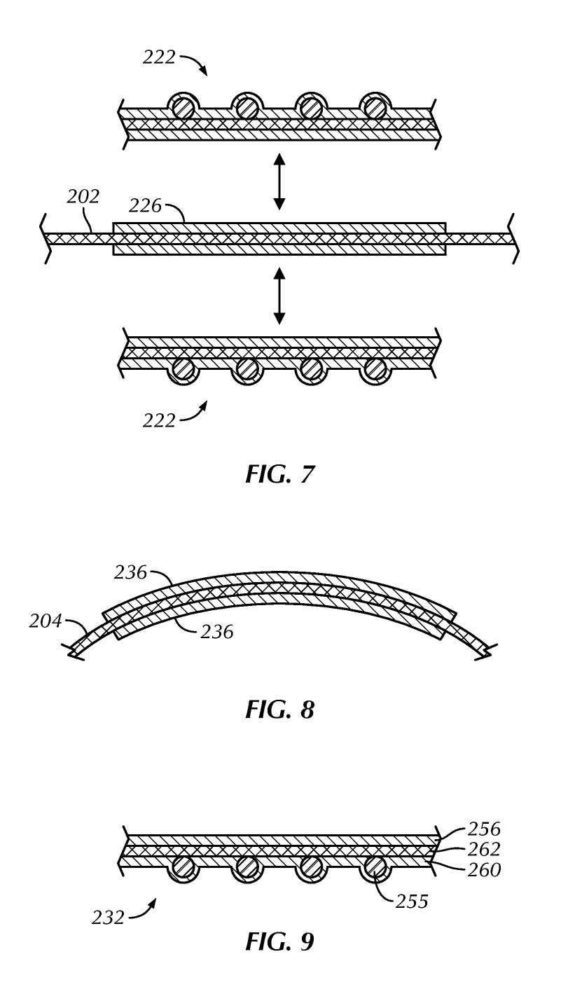

The nose loop 202 is sized to encircle the nose 13 of the animal. The nose loop 202 has an upper segment that aligns with the bridge 15 of the horse's nose, a bottom segment that fits under the chin 14, and a left and right side. The upper segment of the nose loop 202 has an attachment means 226 as illustrated in FIG. 3, such as a Velcro strip or snaps, mounted on a top side of the upper segment and a similar attachment means 226 mounted on the under side of the upper segment. One embodiment of the halter 200 also includes a selectably removable nose pressure band 222 having at least one pressure inducing protrusion embedded therein. The nose pressure band 222 is selectably attached to either the attachment means 226 on the top side of the upper segment or the attachment means 226 or on the under side of the upper segment of the nose loop 202 as shown in FIG. 7.

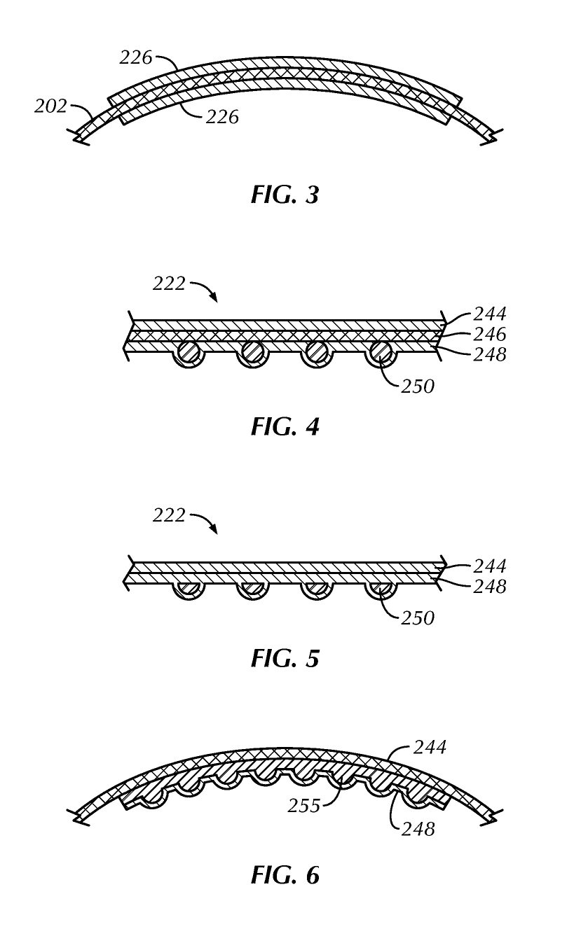

A first embodiment of the nose pressure band 222, as shown in FIG. 4, includes: a nose band attachment means 244, such as a Velcro strip or snaps, and two layers of material 246, 248 with a number of pressure protrusions 250 embedded between the layers 246, 248. The nose pressure band attachment means 244 is compatible and selectably attachable to the attachment means 226. The two layers of material 246 and 248 may the same material or different materials, but are typically flexible and smooth. The top layer of material 246 is securely fastened, by sewing or otherwise, to the nose pressure band attachment means 244. The bottom layer of material 248 must be flexible enough to cover the embedded pressure protrusions 250 along the length of the nose pressure band 222 and yet be securely fastened, by sewing or otherwise, to the bottom layer of material 246 on each side of each embedded pressure protrusion 250.

A second embodiment of the nose pressure band 222, shown in FIG. 5, omits the top layer of material 246 and uses the bottom layer of material 248 to cover each of the pressure protrusions 250 placed along the length of the nose pressure band 222. The bottom layer of material 246 is typically flexible and smooth. The bottom layer of material 248 is securely attached to each end of the nose pressure band attachment means 244 and between each of the pressure protrusions 250.

A third embodiment of the nose pressure band 222, shown in FIG. 6, omits the top layer of material 246 and uses the bottom layer of material 248 to cover a single pressure protrusion layer 258 having separate multiple arcuate surfaces on along its top side that faces the bottom layer of material 248. The bottom layer of material 248 is securely attached to each end of the nose pressure band attachment means 244 with the pressure protrusion layer 258 embedded between the bottom layer of material 248 and the nose pressure band attachment means 244.

A blank nose band (i.e., without pressure protrusions 250) is generally placed over the attachment means 226 on the top side of the upper segment and/or over the attachment means 226 on the under side of the upper segment of the nose loop 202 to provide a smooth surface whenever a nose pressure band 222 is not placed on one or more of the attachment means 226.

The Poll Pressure Band

The head loop 204 is sized to encircle the head 10 of the horse. The head loop 204 has an upper segment that aligns with the poll region 12 behind the horse's ears, a bottom segment that fits under the head toward the neck, and a left and right side. The upper segment of the head loop 204 has an attachment means 236 as illustrated in FIG. 8, such as a Velcro strip or snaps, mounted on a top side of the upper segment and a similar attachment means 236 mounted on the under side of the upper segment. The attachment means 236 may be identical, similar, or different from the attachment means 226.

One embodiment of the halter 200 also includes a selectably removable poll pressure band 232 having at least one pressure inducing protrusion 255 embedded therein. The poll pressure band 232 is selectably attached to either the attachment means 236 on the top side of the upper segment or the attachment means 236 or on the under side of the upper segment of the head loop 204.

A first embodiment of the poll pressure band 232, similar to the nose pressure band shown in FIG. 4, includes: a poll band attachment means 256, such as a Velcro strip or snaps, and two layers of material 260, 262 with a number of pressure protrusions 255 embedded between the layers 260, 262 as shown in FIG. 9. The poll pressure band attachment means 256 is compatible and selectably attachable to the attachment means 236. The two layers of material 260 and 262 may the same material or different materials, but are typically flexible and smooth. The top layer of material 262 is securely fastened, by sewing or otherwise, to the poll pressure band attachment means 256. The bottom layer of material 260 must be flexible enough to cover the embedded pressure protrusions 255 along the length of the poll pressure band 232 and yet be securely fastened, by sewing or otherwise, to the bottom layer of material 260 on each side of each embedded pressure protrusion 255.

A second embodiment of the poll pressure band 232, similar to the nose pressure band shown in FIG. 5, omits the top layer of material 262 and uses the bottom layer of material 260 to cover each of the pressure protrusions 255 placed along the length of the poll pressure band 232. The bottom layer of material 260 is typically flexible and smooth. The bottom layer of material 260 is securely attached to each end of the poll pressure band attachment means 256 and between each of the pressure protrusions 255.

A third embodiment of the poll pressure band 232, similar to the nose pressure band shown in FIG. 6, omits the top layer of material 262 and uses the bottom layer of material 260 to cover a single pressure protrusion layer 258. The bottom layer of material 260 is securely attached to each end of the poll pressure band attachment means 256 with the pressure protrusion layer 258 embedded between the bottom layer of material 260 and the poll pressure band attachment means 256.

A blank poll band (i.e., without pressure protrusions 255) is generally placed over the attachment means 236 on the top side of the upper segment and/or over the attachment means 236 on the under side of the upper segment of the head loop 204 to provide a smooth surface whenever a poll pressure band 232 is not placed on one or more of the attachment means 236.

The Pressure Protrusions

The pressure protrusions 250, 255 are preferably made of a solid material such as metal, plastic or wood and may vary in size and shape. The protrusions 250, 255 push the bottom layer of material 248, 260 away from the band attachment means 244, 256 respectively. Typically the pressure protrusions 250, 255 are shaped such that when embedded in the nose pressure band 222 or the poll pressure band 232 they provide a smooth surface for applying force to the bridge 15 of the nose or the poll region 12. Generally speaking, the larger the pressure protrusion 250, 255 embedded in the nose pressure band 222 or the poll pressure band 232, the more pressure will be applied to the bridge 15 of the nose or the poll region 12.

One example of a pressure protrusion 250, 255 would be a solid spherical material, such as a ball bearing made of metal, plastic or wood. Another example would be a solid material having a semicircular or arcuate profile when seen from a side view.

A variable number of pressure protrusions 250, 255 may be embedded in the nose pressure band 222 or the poll pressure band 232 at regular intervals along the length, or at irregular intervals. All of the pressure protrusions 250, 255 embedded along the length of their respective pressure bands 222, 232 may be of the same size and shape or they may vary in size and shape. For example, larger pressure protrusions 250, 255 may be located in one area of the nose pressure band 222 or the poll pressure band 232 and smaller pressure protrusions 250, 255 may be positioned in different areas of the nose pressure band 222 or the poll pressure band 232.

Nose pressure bands 222 and poll pressure bands 232 are designed to train different sizes and ages of horses or colts. In addition, nose pressure bands 222 and poll pressure bands 232 are designed to work with a horse at different stages of training One embodiment of the halter 200 includes a number of nose pressure bands 222 and poll pressure bands 232 with varying numbers, shapes, sizes and/or hardness of the pressure protrusions 250, 255. FIG. 7 illustrates the ability to attach and detach the nose pressure band 222 from either the upper attachment means 226 on the top side of the upper segment of the nose loop 202 or the lower attachment means on the under side of the upper segment of the nose loop. Thus, nose pressure bands 222 that are made with different types of pressure protrusions 250 can be easily substituted for one another. Specific custom designed nose pressure bands 222 may be designed for a specific horse or colt. Similarly, poll pressure bands made with different types of pressure protrusions 255 can be easily substituted for one another.

One embodiment of the training halter 200 includes a number of nose pressure bands 222 and poll pressure bands 232. Each of the pressure bands 222, 232 are made with varying numbers, shapes, sizes and/or hardness of the pressure protrusions 250, 255. The poll pressure band 232 may have the same or a different design than the nose pressure band 222. For example, the pressure inducing protrusions 255 of the poll pressure band may have a different size, shape, or placement along the poll pressure band than the pressure inducing protrusions 250 of the nose pressure band.

The Shock Absorbing Rope Insert

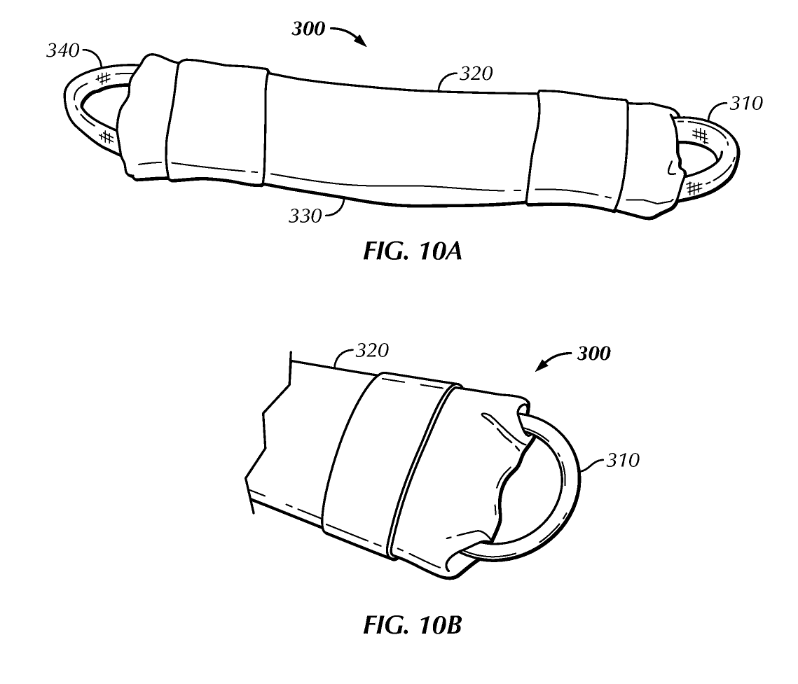

The training halter 200 is most effectively used in conjunction with a stretchable rope insert 300 as shown in FIG. 10A. This stretchable rope insert 300 is inserted into a lead rope that is typically connected to the bottom of the nose loop 202. The stretchable rope insert 300 may be inserted along the length of the lead rope or it may have one end attached to an end on the lead rope and a second end attached to the training halter 200.

The stretchable rope insert 300 cushions the shock that the nose pressure band 222 places on the nose bridge 15 whenever a horse or colt, tied to a lead line with an attached stretchable rope insert 300, bucks or jumps and/or the shock that the poll pressure band 232 places on the poll region 12 whenever a horse or colt tied to the lead with the rope insert 300 pulls back on the lead rope attached to the training halter 200.

One embodiment of the rope insert 300, which lessens the sudden impact on the nose bridge 15 or the poll region 12, is illustrated in FIG. 1. The rope insert 300 has two end loops 310 and a central portion 320. The rope insert 300 is covered with an elastomeric material 330 that is stretchable.

The end loops 310 are typically circular or oval in shape and are connected by the central portion 330. The end loops 310 are made of a strong material that is resistant to ultraviolet degradation and are climate and wear resistant. The end loops 310 should have minimal stretching ability; preferably the end loops will not elongate more than 10% under a pressure force of at least 500 pounds.

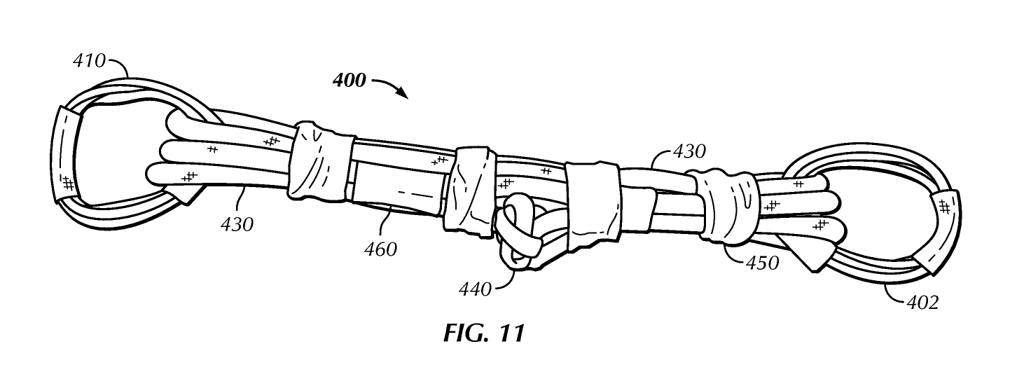

The insert interior 400 (i.e., the rope insert of FIG. 10A without its outer covering 330) is shown in FIG. 11. The insert interior 400 also exhibits two end loops 410 and a central portion 430.

One embodiment of the end loops 310 are shown in FIG. 10A. The internal structure of this embodiment of the end loop 310 is shown in FIG. 11. In this embodiment the end loops 310 represent the end loops 410 covered with a wear resistant material 340. This embodiment of the end loop 410 is made of a strong cord material 402 such as parachute cord. The selected cord 402 exhibits minimal stretching ability and does not elongate more than 10% when 500 pounds of force are applied to the ends of the cord material. Each end loop 410 is made by coiling a length of the cord material 402 multiple times to form a roughly oval loop with an opening. Although the number of coils of the cord material selected for each end loop 410 may vary widely, typically each end loop 410 will contain three to six coils of the cord material 402. Once the cord material 402 has been coiled, the two ends of the cord material are joined together using a square knot or any other joining means known to one skilled in the art. Two opposed sides of the coils of the cord material of each end loop 410 are pulled away from each other and are optionally wrapped, or double wrapped, in a sturdy material 340 for wear protection (e.g., a heat shrink material). The two end loops 410 are connected by the central portion of the rope insert as illustrated in FIG. 11.

Another embodiment of the end loops 310 is seen in FIG. 10B. This embodiment of the end loop 310 is a metal ring. The metal rings are stable to climate conditions and are very wear resistant.

The end loops 310, either the wrapped cord embodiment or the metal ring embodiment, are joined by multiple loosely wound coils of a shock cord 430. The shock cord 430 is wound through the center opening of each end loop 310 for a selected number of coils. Although the number of coils of the shock cord used may vary widely, typically the shock cord 430 will be wound through the center of each end loop 310 from three to six times. The length of the wound shock cord is variable, but should be at least two to three times the diameter of the opening of one of the end loops.

Once the two end loops 310 are connected with the shock chord windings, the two ends of the shock cord 430 are joined using a square knot 440 or any other joining means known to one skilled in the art. The windings of the shock cord 430 are typically held together by an elastomeric material 450, such as large rubber bands. In addition, the shock cord is optionally stabilized by joining one strand of the shock cord, on each side of the joining means 440, with an adjoining strand of the shock cord using an elastomeric material 460, which is the same or different from the material 450 used to hold all of the windings of the shock cord together.

The shock cord 430 must be flexible, strong and elastic. The shock cord 430 must be able to elongate from 50% to 200% (i.e., a 10 inch length of shock cord must be able to elongate to a length of 15 inches to 30 inches) when subjected to a 500 pound force. Preferably, the shock cord 430 will elongate 100% to 140% (i.e., a 10 inch length of shock cord would be able to elongate to a length of 20 inches to 24 inches) under a 500 pound force. For example, an elasticized rope such as a bungee cord may be used as the shock cord 430. However, any engineered stretchable cord that meets the requirements for the shock cord 430 may be used.

Once the insert interior 400 is assembled the insert interior 400 is inserted into a tubular elastomeric material. The ends of the tubular elastomeric material are altered to cover the entire rope insert interior 400, except for a portion of each end loop. The wrapped rope insert 400 is shown in FIG. 10A.

The insert interior is covered with a stretchable elastomeric material 330. One example of a suitable elastomeric material is ethylene propylene diene monomer rubber, or EPDM. The stretchable elastomeric material 330 must be able to stretch or elongate at least 100% and will preferably elongate from 150% to 400% under a 500 pound force. In addition, whatever stretchable material is used to cover the rope insert interior 400 should be heat, ozone, and weather resistant.

If the end loops 310 are made of a non-metallic material, the portion of each end loop that is not wrapped in the outer elastomeric wrap 330 is typically covered with a durable material. The end loop wrap 340, such as shown in FIG. 10A, is typically a flexible but minimally stretchable material that is climate and wear resistant.

Use of the Training Halter

The halter 200 is generally used in conjunction with a lead rope or strap connected to the bottom of the nose loop 202 under the chin of the horse. When utilizing the halter 200 to train a horse, the lead rope can be pulled down (i.e., a downward tension applied to the bottom of the nose loop) so that the pressure protrusions of the nose loop 202 apply pressure to the bridge 15 of the nose 13. Similarly, if the lead rope is pulled away from the horse (i.e., a rearward tension applied to the bottom of the nose loop) the pressure protrusions of the head loop 204 will apply pressure to the poll region 12 of the head.

The training halter 200 is most effectively used in combination with a lead rope attached to a stretchable rope insert 300. The stretchable rope insert 300 may be inserted along the length of the lead rope or it may have one end attached to an end of the lead rope and a second end attached to the training halter 200. The stretchable rope insert 300 cushions the shock that the nose pressure band 222 places on the nose bridge 15 whenever a horse or colt, tied to a lead line with an attached stretchable rope insert 300, bucks or jumps and/or the shock that the poll pressure band 232 places on the poll region 12 whenever a horse or colt tied to the lead with the rope insert 300 pulls back on the lead rope attached to the training halter 200.

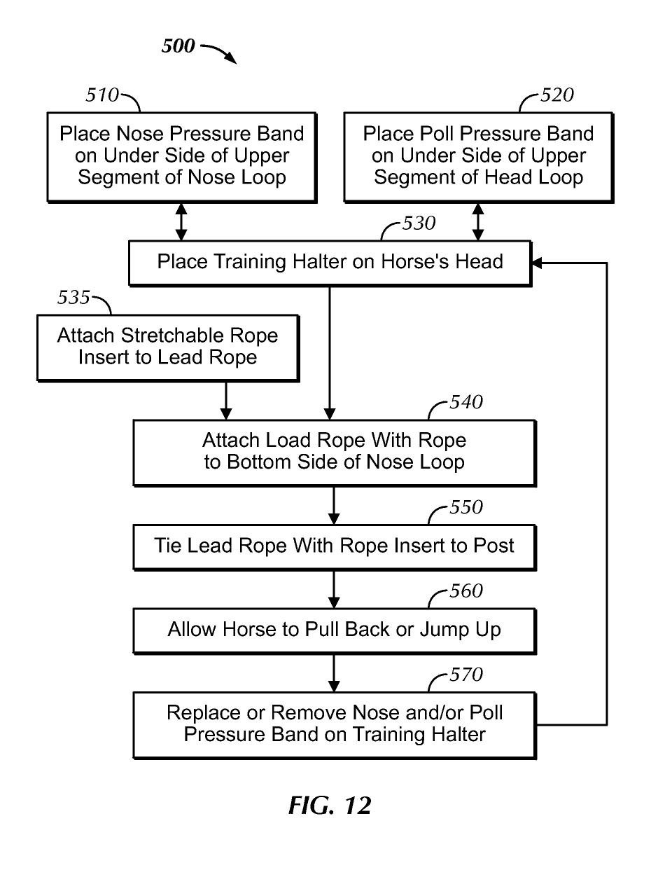

One embodiment of the process of training a horse 500 with a halter 200 having a nose pressure band 222 and/or a poll pressure band 232 is outlined in FIG. 12. The first step is to a nose pressure band 222 and/or poll pressure band 232 having the desired number, placement, size and shape of pressure protrusions 250 or 255 respectively. The selected nose pressure band is then placed on the under side of the upper segment of the nose loop 202 (step 510) and the selected poll pressure band is placed on the under side of the upper segment of the head loop 204 (step 520). The horse is fitted with the training halter 200 with the desired nose pressure band 222 and/or poll pressure band 232 (step 530).

Then a stretchable rope insert 300 is attached to a lead rope either at one of its ends or inserted along the length of the lead rope (step 535). One end of the lead rope with the attached rope insert 300 is then attached to the bottom side of the nose loop 202 (step 540) and an opposed end of the lead rope is tied to a post (step 550). The horse is then allowed to jump up or pull back (step 560). Thus, whenever the horse bucks or pulls back on the lead rope, pressure is applied to the poll region and/or to the nose of the horse.

Often when a horse is initially being trained to a lead rope a nose pressure band 222 and/or poll pressure band 232 with larger pressure protrusions 250, 255 is selected and the stretchable rope insert 300 serves to cushions and ease the initial shock that the nose pressure band 222 places on the nose bridge 15 and/or the initial shock that the poll pressure band 232 places on the poll region 12 whenever a horse or colt tied to the lead rope having an attached rope insert 300 bucks or pulls back on the lead rope attached to the training halter 200. The harder the horse pulls against the lead rope, the greater the pressure applied. Thus, the horse is encouraged not to buck and not to pull back while tied to a lead rope.

If after the first session, the horse is still prone to pull against the lead rope by jumping, bucking or sitting back the nose pressure band 222 or the poll pressure band 232 is replaced with another configuration of nose and/or poll pressure band and/or one of the pressure bands may be removed and replaced with a blank band without pressure protrusions (see step 570). Once the training halter is reconfigured, it is replaced on the horse's head and steps 530, 540, 550, 560 and 560 or repeated as needed.

Having shown and described various embodiments of the present invention, further adaptations of the halter 200 described herein may be accomplished by appropriate modifications in materials and dimensions by one of ordinary skill in the art without departing from the scope of the present invention.

What is claimed is:

1. A training halter for horses comprising:
a. a nose loop configured to encircle a nose of a horse, the nose loop having an upper segment that aligns with a bridge of the nose of the horse and a bottom segment positional under a chin of the horse;
b. a first nose pressure band having a plurality of nose pressure protrusions embedded therein, the nose pressure band selectably attachable to a top side of the upper segment of the nose loop or to a bottom side of the upper segment of the nose loop, wherein when the nose pressure band is attached to the bottom side of the upper segment of the nose loop the nose pressure protrusions transmit pressure to the bridge of the nose whenever a downward tension is applied to the training halter;
c. a head loop configured to encircle a head of the horse, the head loop having an upper segment that aligns with a poll region of the horse; and
d. a first poll pressure band having a plurality of poll pressure protrusions embedded therein, the poll pressure band selectably attachable to a top side of the upper segment of the head loop or to a bottom side of the upper segment of the head loop, wherein when the poll pressure band is attached to the bottom side of the upper segment of the head loop the poll pressure protrusions transmit pressure to the poll region whenever a rearward tension is applied to the training halter.

2. The training halter of claim 1, further comprising a blank nose band and a blank poll band.

3. The training halter of claim 1, further comprising a second nose pressure band having a plurality of nose pressure protrusions, wherein the pressure protrusions of the second nose pressure band are smaller than the pressure protrusions of the first nose pressure band.

4. The training halter of claim 1, further comprising a second poll pressure band having a plurality of poll pressure protrusions, wherein the pressure protrusions of the second poll pressure band are smaller than the pressure protrusions of the first poll pressure band.

5. The training halter of claim 1, wherein the nose pressure protrusions are a different size or shape than the poll pressure protrusions.

6. The training halter of claim 1, further comprising a stretchable rope insert.

7. The training halter of claim 6, further comprising a lead rope attached to the stretchable rope insert.

8. The training halter of claim 6, wherein the stretchable rope insert comprises
a) a first end loop and a second end loop, wherein each end loop has multiple coils of a cord material and wherein a first end and a second end of the coiled cord material are joined to form a substantially oval loop with an opening,
b) an expandable shock cord joining the first and second end loops, wherein the shock cord is wound multiple times between the opening in the first end loop and the opening in the second end loop, wherein a first end and a second end of the wound shock cord are joined, and
c) a stretchable elastomeric cover fitted to cover the wound shock cord and a portion of the first and second end loops.

9. The training halter of claim 7, wherein the expandable shock cord expands between 50% and 200% in length under a 500 pound force.

10. An apparatus for training horses including:
a. a training halter having
i) a nose loop configured to encircle a nose of a horse, the nose loop having an upper segment that aligns with a bridge of the nose of the horse and a bottom segment positional under a chin of the horse,
ii) a first nose pressure band having a plurality of nose pressure protrusions embedded therein, the nose pressure band selectably attachable to a top side of the upper segment of the nose loop or to a bottom side of the upper segment of the nose loop, wherein when the nose pressure band is attached to the bottom side of the upper segment of the nose loop the nose pressure protrusions transmit pressure to the bridge of the nose whenever a downward tension is applied to the training halter,
iii) a head loop configured to encircle a head of the horse, the head loop having an upper segment that aligns with a poll region of the horse, and
iv) a first poll pressure band having a plurality of poll pressure protrusions embedded therein, the poll pressure band selectably attachable to a top side of the upper segment of the head loop or to a bottom side of the upper segment of the head loop, wherein when the poll pressure band is attached to the bottom side of the upper segment of the head loop the poll pressure protrusions transmit pressure to the poll region whenever a rearward tension is applied to the training halter; and
b. a stretchable rope insert in communication with the training halter having
i) a first end loop and a second end loop, wherein each end loop has multiple coils of a cord material and wherein a first end and a second end of the coiled cord material are joined to form a substantially oval loop with an opening,
ii) an expandable shock cord joining the first and second end loops,
wherein the shock cord is wound multiple times between the opening in the first end loop and the opening in the second end loop, wherein a first end and a second end of the wound shock cord are joined, and
iii) a stretchable elastomeric cover fitted to cover the wound shock cord and a portion of the first and second end loops; and
c. a lead rope attached to the stretchable rope insert.

11. The apparatus for training horses of claim 10, further comprising a blank nose band and a blank poll band.

12. The apparatus for training horses of claim 10, further comprising a second nose pressure band having a plurality of nose pressure protrusions, wherein the pressure protrusions of the second nose pressure band are smaller than the pressure protrusions of the first nose pressure band.

13. The apparatus for training horses of claim 10, further comprising a second poll pressure band having a plurality of poll pressure protrusions, wherein the pressure protrusions of the second poll pressure band are smaller than the pressure protrusions of the first poll pressure band.

14. The apparatus for training horses of claim 10, wherein the expandable shock cord expands between 50% and 200% in length under a 500 pound force.

15. The apparatus for training horses of claim 10, wherein the nose pressure protrusions are a different size or shape than the poll pressure protrusions

16. A method for training a horse including:
a) selecting a first nose pressure band having a plurality of nose pressure protrusions embedded therein;
b) selecting a first poll pressure band having a plurality of poll pressure protrusions embedded therein;
c) attaching the first nose pressure band on an under side of an upper segment of a nose loop of a training halter;
d) attaching the first poll pressure band on an under side of an upper segment of a head loop of a training halter;
e) placing the training halter on a head of the horse being trained such that the nose loop encircles a nose of the horse and the nose pressure protrusions are aligned with a bridge of the nose and the head loop encircles the head of the horse and the poll pressure protrusions are aligned with a poll region of the horse;
f) attaching a stretchable rope insert to a lead rope;
g) attaching the lead rope with the rope insert to a bottom side of the nose loop;
h) tying one end of the lead rope to a post; and
i) allowing the horse to rear thereby causing the nose pressure protrusions to pressure the bridge of the nose of the horse, or to pull back thereby causing the poll pressure protrusions to pressure the poll region of the horse.

17. The method for training horses of claim 16, further comprising replacing the first nose pressure band with a second nose pressure band and replacing the training halter on the head of the horse.

18. The method for training horses of claim 16, further comprising replacing the first poll pressure band with a second poll pressure band and replacing the training halter on the head of the horse.
